(19) United States
(12) Patent Application Publication
(10) Pub. No.: US 2020/0291898 A1
(43) Pub. Date: Sep. 17, 2020

(54) AUXILIARY BOOSTER WITH OPTIMISED ARCHITECTURE

(71) Applicant: ARIANEGROUP SAS, Paris (FR)

(72) Inventors: Nicolas CUCCO, Gradignan (FR); Jean-Baptiste DEYTS, Concise (CH); Pierre LAVEZE, Le Bouscat (FR); Jean-Michel LARRIEU, Macau (FR)

(73) Assignee: ARIANEGROUP SAS, Paris (FR)

(21) Appl. No.: 16/768,111

(22) PCT Filed: Nov. 29, 2018
(86) PCT No.: PCT/FR2018/053053

§ 371 Date: May 29, 2020

(30) Foreign Application Priority Data
Dec. 1, 2017 (FR) 1701269

(51) Int. Cl. F02K 9/24; F02K 9/08; F02K 9/34; F02K 99/00

(52) U.S. Cl. CPC F02K 9/24; F02K 99/00; F02K 9/34; F02K 9/08

(57) ABSTRACT

A solid propellant auxiliary booster intended to be attached to the main body of a launcher comprises a cylindrical body extending in a longitudinal direction between a rear face in communication with a nozzle and a front face formed by a conical structure connected to the cylindrical body of the booster. The cylindrical body delimits a first internal volume and the conical structure of the front face delimits a second internal volume. The auxiliary booster contains a solid propellant charge. The first internal volume of the cylindrical body communicates with the second internal volume of the conical structure. The solid propellant charge is present both in the first and second internal volumes.

### BACKGROUND OF THE INVENTION

The invention relates to the field of solid propellant boosters, and more particularly, auxiliary boosters intended to be attached to the main body of a launcher.

As illustrated in FIG. 1, an auxiliary booster 10 comprises a shell 11 having a cylindrical shape extending in a longitudinal direction between a rear face 12 in communication with a nozzle 13 and a closed front face 14. The shell 11, which constitutes the reservoir of the auxiliary booster, contains a solid propellant charge 17, an initiation device 18 being present at the front face 14 of the shell. The front face 14 of the shell 11 is covered with a cap or conical structure 15 which ensures aerodynamic protection of the front face. The cap 15 is attached to the shell 11 by means of a skirt 16 applied to the front face of the shell.

Document U.S. Pat. No. 5,131,610 discloses an auxiliary booster of this type. The connection between the skirt 16 and the front face of the shell

11, on the one hand, the connection between the cap 15 and the skirt 16, on the other hand, must have excellent mechanical strength in order to resist the aerodynamic loads to which the auxiliary booster is subjected. These parts, as well as their connections, are costly and complex to implement.

Thus there exists a need for solid propellant auxiliary boosters having reduced manufacturing costs.

### OBJECT AND SUMMARY OF THE INVENTION

This aim is achieved thanks to a solid propellant auxiliary booster intended to be attached to the main body of a launcher, the booster comprising a cylindrical body extending in a longitudinal direction between a rear face in communication with a nozzle and a front face formed by a conical structure connected to the cylindrical body of the booster, the cylindrical body delimiting a first internal volume and the conical structure of the front face delimiting a second internal volume, said auxiliary booster containing a solid propellant charge, characterized in that the first internal volume of the cylindrical body communicates with the second internal volume of the conical structure, in that the solid propellant charge is present both in the first and second internal volumes and in that the auxiliary booster also comprises an ignition device of the solid propellant charge present at the rear face of said auxiliary booster.

In producing a conical structure in the continuation of the cylindrical body of the booster, the architecture of the front portion of the booster is greatly simplified, in particular because it is no longer necessary to apply a skirt to ensure the connection between the body of the booster and the aerodynamic protection element, nor to have to manage delicate connections between three elements (booster shell, skirt and cap).

In addition, by combining the internal volume of the cylindrical body with the internal volume of the conical structure, the solid propellant charging capacity of the auxiliary booster is increased. Consequently, for a given charge volume, it is possible to produce auxiliary boosters with smaller dimensions and to thus further reduce their manufacturing cost.

Moreover, placing an ignition device for the solid propellant charge at the rear face of the auxiliary booster allows optimizing the charge volume in the assembly formed by the cylindrical body and the conical structure.

According to one embodiment of the auxiliary booster of the invention, the cylindrical body and the conical structure of the front face are of metallic material.

According to another embodiment of the auxiliary booster of the invention, the cylindrical body and the conical structure of the front face are of organic matrix composite material.

The invention also has as its object a manufacturing method of a solid propellant auxiliary booster intended to be attached to the main body of a launcher, the booster comprising a cylindrical body extending in a longitudinal direction between a rear face in communication with a nozzle and a front face formed by a conical structure connected to the cylindrical body of the booster, the cylindrical body delimiting a first internal volume and the conical structure of the front face delimiting a second internal volume, said auxiliary booster containing a solid propellant charge, characterized in that the method comprises the production of an assembly comprising the cylindrical body and the conical structure forming the front face of the booster, the first internal volume of the cylindrical body communicating with the second internal volume of the conical structure, in that the solid propellant charge is present both in the first and second internal volumes, and in that an ignition device of the solid propellant charge is placed at the rear zone of said auxiliary booster.

According to one embodiment of the invention, the assembly comprising the cylindrical body and the conical structure of the front face is produced of metallic material, the conical structure being attached by welding or brazing or other mechanical connection to the upstream end of the cylindrical body.

According to one particular feature of the method of the invention, each of the cylindrical body and the conical structure of the front face are charged with solid propellant before or after their assembly.

According to one particular feature of the method of the invention, the cylindrical body is produced by assembly of a plurality of cylindrical shroud segments, each segment being charged with solid propellant before or after its assembly with another segment.

According to another embodiment of the invention, the assembly comprising the cylindrical body and the conical structure of the front face is produced in organic matrix composite material. The cylindrical body and the conical structure can be produced together, i.e. in a single piece. The cylindrical body and the conical structure can also be produced separately and then assembled together, the cylindrical body and the conical structure being able to be charged with solid propellant before or after their assembly. The cylindrical body can also be produced from shroud segments manufactured independently of one another and then assembled, the segments being able to be charged with solid propellant before or after their assembly.

### BRIEF DESCRIPTION OF THE DRAWINGS

Other features and advantages of the invention will be revealed by the following description of particular embodiments of the invention, given by way of non-limiting examples, with reference to the appended drawings, in which:

FIG. 1 is a schematic section view of an auxiliary booster according to the prior art,

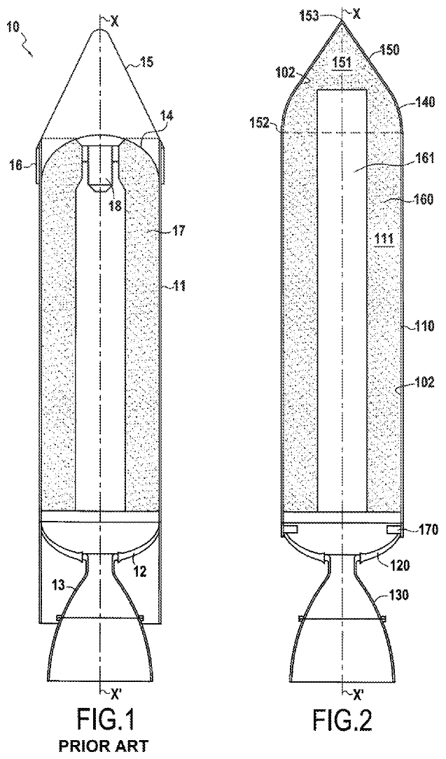

FIG. 2 is a schematic section of an auxiliary booster conforming to one embodiment of the invention,

FIGS. 3A to 3D show the manufacturing steps of the auxiliary booster of FIG. 2,

FIG. 4 shows a manufacturing alternative of the booster of FIG. 2,

FIG. 5 is a schematic section of an auxiliary booster conforming to an embodiment of the invention,

FIGS. 6A to 6D show the manufacturing steps of the auxiliary booster of FIG. 4,

FIG. 7 shows a manufacturing alternative of the booster of FIG. 5.

### DETAILED DESCRIPTION OF EMBODIMENTS

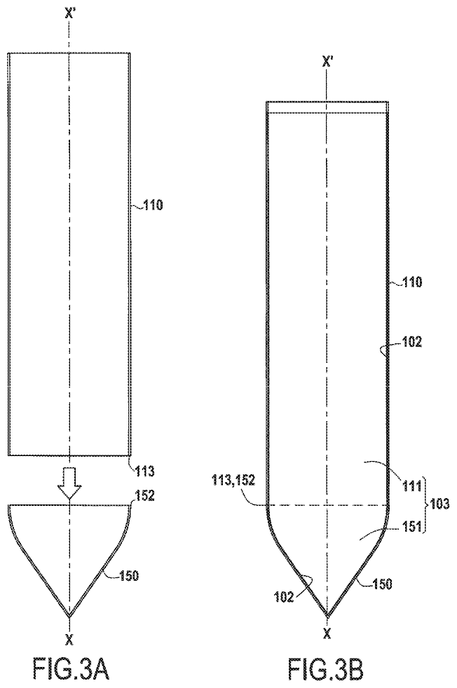

FIG. 2 shows an auxiliary booster 100 conforming to an embodiment of the invention. The auxiliary booster 100 comprises a cylindrical body 110 extending in a longitudinal direction X-X′ between a rear zone or portion 120 which, in the example described here, is in communication with a nozzle 130 and a front face 140 formed by a conical structure 150 connected to the cylindrical body 110 of the booster.

In this embodiment, the cylindrical body 110 and the conical structure 150 forming the front face 140 are produced of metallic material, for example steel or titanium or aluminum.

The cylindrical body 110 delimits a first internal volume 111 while the conical structure 150 of the front face 140 delimits a second internal volume 151. In conformity with the invention, the first internal volume 111 of the cylindrical body 110 communicates with the second internal volume 151 of the conical structure 150. Still in conformity with the invention, a solid propellant charge 160 is present both in the first and second internal volumes 111 and 151. In other words, in the present invention, the shell of the reservoir of the auxiliary booster is constituted both by the cylindrical body 110 and the conical structure 150 of the front face 140 which form together (combination of the first and second internal volumes 111 and 151) a common volume occupied by the solid propellant charge 160, differing from the auxiliary boosters of the prior art like that described in document U.S. Pat. No. 5,131,610, in which the shell forming the solid propellant reservoir is closed at the front face of the cylindrical body, preventing communication between the internal volume of the cylindrical body and the conical structure applied to the front face of the auxiliary booster.

One layer of a thermal protection material 102 is present on the internal surface of the cylindrical body 110 and of the conical structure 150.

The solid propellant charge 160 includes a central channel 161 extending in the longitudinal direction X-X′ and forming a combustion chamber as well as a duct for circulating the hot gases originating in the combustion of the propellant in the direction of the nozzle 130.

In the example described here, the propellant charge 160 is present in particular in the entire internal volume 151 of the conical structure, i.e. from the rear end 152 until the front end 153 of the conical structure 150. Still in the example described here, the central channel 161 present in the solid propellant charge 160 is interrupted at an intermediate position located between the rear end 152 and the front end 153 of the conical structure 150.

The central channel can also extend until the front end 153 of the conical structure 150.

The booster 100 also comprises an ignition device 170 for the solid propellant charge 160 present inside the cylindrical body in proximity to the rear zone 120 of the booster.

The booster 100 can also comprise a rear coupling device (not shown in FIG. 2) which, depending on the specific design of the auxiliary booster, is located at the skirt of the rear zone or the lower portion of the cylindrical body 110 and a front coupling device (not shown in FIG. 2) which, depending on the specific design of the auxiliary booster, is located at the conical structure 150 or the upper portion of the cylindrical body 110. The coupling devices are intended to allow the attachment of the auxiliary booster to the main body of a launcher (not shown in FIG. 2).

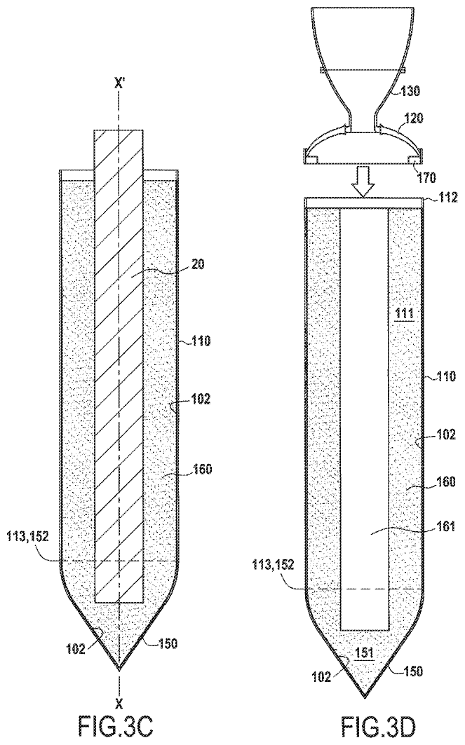

As illustrated in FIGS. 3A to 3D, two parts, corresponding respectively to the cylindrical body 110 and to the conical structure 150 (FIG. 3A) are produced independently from a metallic material for the manufacture of the auxiliary booster 100. The cylindrical body 110 and the conical structure 150 are then assembled by attaching the rear end 152 of the conical structure 150 to the front end 113 of the cylindrical body 110 by welding or brazing or another mechanical assembly (FIG. 3B). After having formed the thermal protection material layer 102 on the inner surface of the cylindrical body 110 and the conical structure 150, the solid propellant charge 160 is poured into the internal common volume 103 consisting of the combination of the internal volume 111 of the cylindrical body 110 and of the internal volume 151 of the conical structure 150 (FIG. 3B) by using tooling allowing the provision of the central channel 161 in the charge (FIG. 3C). The rear zone 120, equipped here with the nozzle 130 and with the ignition device 170, is then attached to the rear end 112 of the cylindrical body 110 by welding or brazing or another mechanical connection (FIG. 3D). The auxiliary booster 100 as shown in FIG. 2 is then obtained.

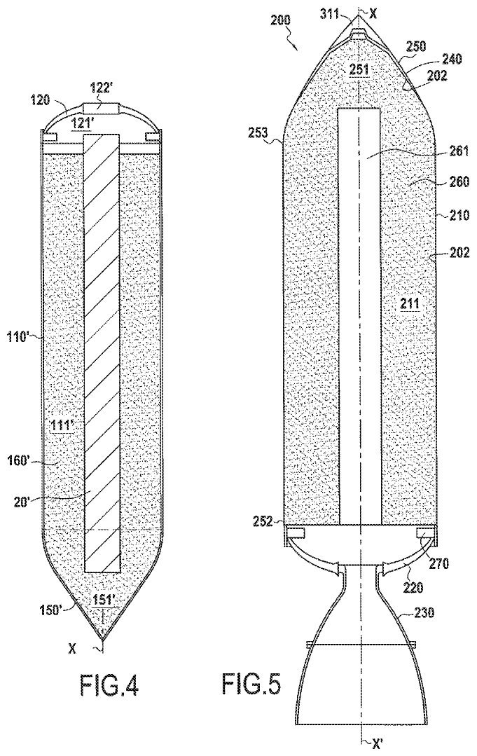

According to a variant embodiment illustrated in FIG. 4, the cylindrical body 110′, the conical structure 150′ and the rear zone 120′ are assembled prior to filing the booster with the solid propellant. In this case, the solid propellant 160′ is poured into the common internal volume constituted by the combination of the internal volume 111′ of the cylindrical body 110′, the internal volume 151′ of the conical structure 150′ and possibly all or part of the internal volume 121′ of the rear zone 120′. The solid propellant is poured through the opening 122′ present in the rear zone 120′ and by using tooling 20′ allowing the provision of the central channel in the solid propellant charge 160′.

According to another variant embodiment of the auxiliary booster 100, each of the cylindrical body 110 and the conical structure 150 can be charged with solid propellant before their assembly.

According to another variant embodiment of the auxiliary booster 100, the cylindrical body 110 is produced by assembly of a plurality of cylindrical shroud segments, each segment being charged with solid propellant before its assembly with another segment.

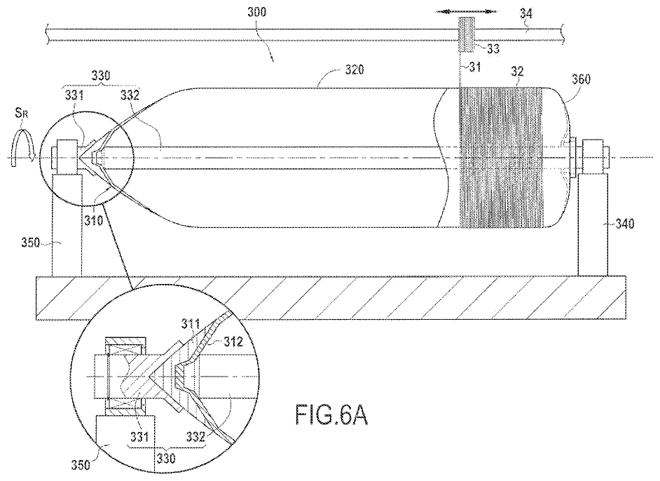

FIG. 5 illustrates an auxiliary booster 200 according to another embodiment of the invention and which differs from the auxiliary booster 100 described above in that at least the cylindrical body and the conical structure forming the front end of the booster are made of composite material, namely a fibrous reinforcement densified by a matrix.

As for the auxiliary booster 100 described previously, the auxiliary booster 200 comprises a cylindrical body 210 extending in a longitudinal direction X-X′ between a rear portion or zone 220 which, in the example described here, is in communication with a nozzle 230 and a front face 240 formed by a conical structure 250 extending in the continuation of the cylindrical body 210 in the axial direction X-X′.

The cylindrical body 210 delimits a first internal volume 211 while the conical structure 250 of the front face 240 delimits a second internal volume 251. In conformity with the invention, the first internal volume 211 of the cylindrical body 210 communicates with the second internal volume 251 of the conical structure 250. Still in conformity with the invention, a solid propellant charge 260 is present both in the first and second internal volumes 211 and 251.

In other words, in the auxiliary booster reservoir shell is constituted both by the cylindrical body 210 and the conical structure 250 of the front face 240 which together form (combination of the first and second internal volumes 211 and 251) a common volume occupied by the solid propellant charge 260, differing from the auxiliary boosters of the prior art like that described in document U.S. Pat. No. 5,131,610 and in which the shell forming the reservoir for the solid propellant is closed at the front face of the cylindrical body, preventing communication between the internal volume of the cylindrical body and the conical structure applied to the front face of the auxiliary booster.

A layer of a thermal protection material 202 is present in the inner surface of the cylindrical body 210 and of the conical structure 250. The solid propellant charge 260 includes a central channel 261 extending in the longitudinal direction X-X′ and forming a combustion chamber as well as a duct for circulating the hot gases originating from the combustion of the propellant in the direction of the nozzle 230.

In the example described here, the propellant charge 260 is present in particular in the entire internal volume 251 of the conical structure, i.e. from the front end 252 until the front end 253 of the conical structure 250. Still in the example described here, the central channel 261 present in the solid propellant charge 260 is interrupted at an intermediate position located between the rear end 252 and the front end 253 of the conical structure 250. The central channel can also extend to the front end 253 of the conical structure 250.

The booster 200 also comprises an ignition device 270 of the solid propellant charge 260 present in the interior of the cylindrical body in proximity to the rear face 220 of the booster.

The booster 200 can also comprise a rear coupling device (not shown in FIG. 5) which, depending on the specific design of the auxiliary booster, is located at the rear zone 220, the skirt of the rear zone or the lower portion of the cylindrical body 210, and a front coupling device (not shown in FIG. 5) which, depending on the specific design of the auxiliary booster, is located at the conical structure 250, the point 311 or the upper portion of the cylindrical body 210. The coupling devices are intended to allow the attachment of the auxiliary booster to the main body of a launcher (not shown in FIG. 5).

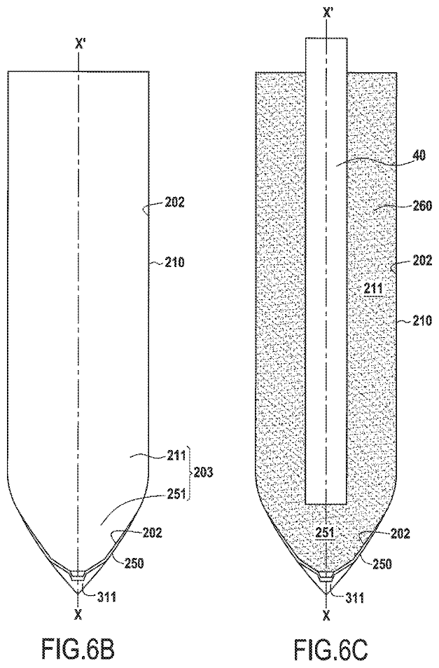

The cylindrical body 210 and the conical structure 250 are produced together by filament winding as illustrated in FIG. 6A. To this end, a mandrel 300 is used including, in its front portion, a base 310 intended to allow the formation of the conical structure 250, a cylinder 320 connected to the base 310 for the formation of the cylindrical body 210 and a rear portion 360 allowing the mandrel to be supported on a rotating shaft on its rear portion. The base 310 comprises a conical point 311 intended to form the front end of the conical structure 250 secured to a conical support 312 widening on the side opposite the conical point 311. The conical point 311 and the conical support 312 can be produced from a composite or metallic material.

The conical point 311 is retained in a first element or counter-point 331 of the shaft 330 of the mandrel 300. A second element 332 of the rotating shaft 300 is connected both to the inner surface of the base 310, i.e. on the side opposite the one including the point 311, and to the rear portion 360 of the cylinder 320. The shaft 330 is supported by two pins 340 and 350, at least one of which comprises a motor (not shown) to drive the mandrel 300 in rotation in the direction indicated by the arrow SR in FIG. 5A. The pin 340 can for example comprise a motor and be secured to the rear portion 360 so as to drive the cylinder 320 in rotation.

In the example described here, the cylindrical body 210 and the conical structure 250 are produced by continuous winding of a strand 31 by means of a winding-laying head 33 capable of moving parallel to the axis of the mandrel 300 on a rail 34 so as to form a winding 32 on the mandrel 300. The strand 31 is impregnated with a precursor of the matrix, or with the matrix itself. The direction of the winding on the mandrel is adjust depending on the orientation of the strands of the fibrous reinforcement that it is desired to obtain. The cylindrical body and the conical structure can also be produced by draping fibrous plies on the mandrel 300.

The cylindrical body 210, the rear end 220 and the conical structure 250 can in particular be produced by winding or draping of an organic matrix composite (thermosetting or thermoplastic).

An elastomer strip winding can be produced on the mandrel 300 before the filament winding of the strand 31 in order to form the internal layer of thermal protection material 202 of the booster.

Once the winding is finished, depending on the nature of the matrix, the polymerization or hardening of the resin is carried out so as to form a structural shell comprising the cylindrical body 210 and the conical structure 250 as illustrated in FIG. 6B. The solid propellant charge 260 is then poured into the common internal volume 203 consisting of the combination of the internal volume 211 of the cylindrical body 210 and of the internal volume 251 of the conical structure 250 (FIG. 6B) by using tooling 40 allowing the provision of the central channel 261 in the charge (FIG. 6C). The rear zone 220 is then attached, equipped here with the nozzle 230 and the ignition device 270, to the rear end 212 of the cylindrical body 210, by adhesion for example (FIG. 6D). The auxiliary booster 200 as shown in FIG. 4 is then obtained.

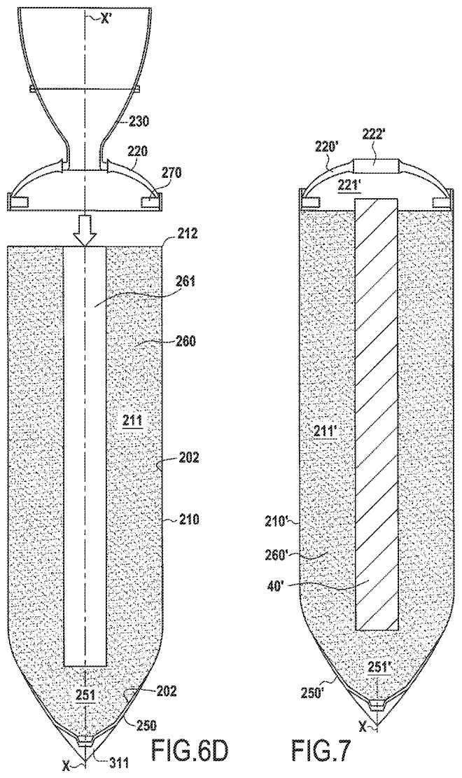

According to a variant embodiment illustrated in FIG. 7, the cylindrical body 210′, the conical structure 250′ and the rear zone 220′ are produced together or assembled before filling the booster with the solid propellant. In this case, the solid propellant 260′ is poured into the common internal volume consisting of the combination of the internal volume 211′ of the cylindrical body 210′, the internal volume 251′ of the conical structure 250′ and possibly all or a portion of the internal volume 221′ of the rear zone 220′. The solid propellant is poured through the opening 222′ present on the rear zone 220′ and by using tooling 40′ allowing the provision of the central channel in the solid propellant charge 260′.

The cylindrical body and the conical structure of composite material can be produced together, i.e. in a single piece. The cylindrical body and the conical structure can also be produced separately and then assembled together, the cylindrical body and the conical structure being able to be charged with solid propellant before or after their assembly. The cylindrical body can also be produced from shroud segments manufactured independently of one another and then assembled, the segments being able to be charged with solid propellant before or after their assembly.

Moreover, the elements constituting the auxiliary booster, namely the cylindrical body, the conical structure forming the front face and the rear zone, can be produced, some of metallic material and others of composite material. For example, an auxiliary booster of the invention can consist of a cylindrical body of composite material with a front face and a rear zone of metallic material.

1. A solid propellant auxiliary booster intended to be attached to the main body of a launcher, the booster comprising a cylindrical body extending in a longitudinal direction between a rear zone in communication with a nozzle and a front face formed by a conical structure connected to the cylindrical body of the booster, the cylindrical body delimiting a first internal volume and the conical structure of the front face delimiting a second internal volume, said auxiliary booster containing a solid propellant charge, wherein the first internal volume of the cylindrical body communicates with the second internal volume of the conical structure, in communicates that the solid propellant charge is present both in the first and second internal volumes and wherein the auxiliary booster also comprises an ignition device of the solid propellant charge present at the rear zone of the auxiliary booster.

2. The auxiliary booster according to claim 1, wherein the cylindrical body and the conical structure of the front face are of metallic material.

3. The auxiliary booster according to claim 1, wherein the cylindrical body and the conical structure of the front face are of organic matrix composite material.

4. The auxiliary booster according to claim 1, wherein the cylindrical body is of composite material and the front face of metallic material.

5. A manufacturing method of a solid propellant auxiliary booster intended to be attached to the main body of a launcher, the booster comprising a cylindrical body extending in a longitudinal direction between a rear zone in communication with a nozzle and a front face formed by a conical structure connected to the cylindrical body of the booster, the cylindrical body delimiting a first internal volume and the conical structure of the front face delimiting a second internal volume said auxiliary booster containing a solid propellant charge wherein the method comprises the production of an assembly comprising the cylindrical body and the conical structure forming the front face of the booster, the first internal volume of the cylindrical body communicating with the second internal volume of the conical structure, wherein the solid propellant charge is present both in the first and second internal volumes and in that an ignition device of the solid propellant charge is placed at the rear zone of the auxiliary booster.

6. The method according to claim 5, wherein the cylindrical body and the conical structure of the front face are produced of metallic material, the conical structure being attached to the upstream end of the cylindrical body.

7. The method according to claim 6, wherein each of the cylindrical body and the conical structure of the front face is charged with solid propellant before or after their assembly.

8. The method according to claim 7, wherein the cylindrical body is produced by assembly of a plurality of cylindrical shroud segments, each segment being charged with solid propellant before or after its assembly with another segment.

9. The method according to claim 5, wherein the assembly comprising the cylindrical body and the conical structure of the front face is produced from organic matrix composite material on a mandrel corresponding to the shape of said assembly.

10. The method according to claim 5, wherein the assembly comprising the cylindrical body and the conical structure of the front face is produced of organic matrix composite material, the conical structure being attached by mechanical connection to the upstream end of the cylindrical body.

11. The method according to claim 5, wherein the cylindrical body is produced of organic matrix composite material while the conical structure of the front face is produced of metallic material, the conical structure being attached by mechanical connection to the upstream end of the cylindrical body.

12. The method according to claim 10, wherein each of the cylindrical body and the conical structure of the front face are charged with solid propellant before or after their assembly.

13. The method according to claim 10, wherein the cylindrical body is produced by assembly of a plurality of cylindrical shroud segments, each segment being charged with solid propellant before or after its assembly with another segment.
